(19) United States
(12) Patent Application Publication
(10) Pub. No.: US 2024/0154557 A1
(43) Pub. Date: May 9, 2024

(54) SWITCHED RELUCTANCE MOTOR WITH SEVERAL SINGLE-PHASE SLICES

(71) Applicant: CHARA TECHNOLOGIES PRIVATE LIMITED, BENGALURU (IN)

(72) Inventors: BHAKTHA RAM KESHAVACHAR, BENGALURU (IN); RAVI PRASAD SHARMA, BENGALURU (IN); MAHALINGAM KOUSHIK BALASUBRAMANIAN, BENGALURU (IN)

(21) Appl. No.: 18/549,047

(22) PCT Filed: Mar. 5, 2022
(86) PCT No.: PCT/IN2022/050199

§ 371 Date: Sep. 5, 2023

(30) Foreign Application Priority Data
Mar. 5, 2021 (IN) 202141009356

(51) Int. Cl. H02P 25/098

(52) U.S. Cl. CPC H02P 25/098

(57) ABSTRACT

The embodiments herein provide a multitude of single-phase Switch Reluctance Motor (SRM) arranged in a suitable fashion in order to achieve uniform torque with complete material utilization. The embodiment herein also provides a series of single-phase Switch Reluctance Motor (SRM) arranged in appropriate manner for better utilization of material leading to better efficiencies, reduced cost, reduced size or weight and reduction in torque ripple and noise. In addition, the embodiments herein also provide a two-slice SRM system and method, which correspondingly resolves the starting problem.

### CROSS-REFERENCE TO RELATED APPLICATIONS

The present application is a National Phase Application of the Patent Cooperation Treaty (PCT) international stage application with serial number PCT/IN2022/050199 filed on 5 Mar. 2022. The aforementioned PCT international phase application claims priority to the Indian Provisional Patent Application (PPA) with serial number 202141009356 filed on Mar. 5, 2021, with the title “SWITCHED RELUCTANCE MOTOR WITH SEVERAL SINGLE-PHASE SLICES”. The contents of which are incorporated in entirety as reference herein.

### BACKGROUND

### Technical Field

The embodiments herein generally relate to switched reluctance motor (SRM). The embodiments herein are particularly related to multitude of single-phase Switch Reluctance Motor (SRM) arranged in a suitable fashion, to achieve uniform torque with complete material utilization. The embodiments herein are more particularly related to series of single-phase Switch Reluctance Motor (SRM) arranged in suitable fashion for better utilization of material leading to better efficiencies, reduced cost and reduced size or weight.

### Description of the Related Art

Switched Reluctance Motor or SRM is one among the currently known motors, which is being applied to industrial systems and home appliances due to its simple and robust mechanical structure, excellent traction torque, low manufacturing cost and minimal maintenance cost. In particular the SRM does not include a permanent magnet, a brush, and a commutator. Moreover, a SRM or a Switched Reluctance Motor has a stator, which includes salient poles and has a structure in which steels are stacked and winding around which coils connected in series with each other are wound are independently connected to the respective phases and enclose stator poles. A rotor does not include a winding, has a structure in which steels are stacked, and includes salient poles, similar to the stator. Therefore, since both of the stator and the rotor have the salient pole structure, the SRM may be considered as having a double salient pole type structure. Hence, due to the simple structure of the SRM, the reliability is increased, and production cost is decreased.

Although SRMs have assured low cost, higher efficiency, simpler construction, and magnet free properties for a long time but remains unproductive. The principal reason for low production is the low material utilization in conventional SRM. In a conventional SRM one or at most two phases are active at any point in time, which leads to lower efficiency, higher costs, and increased weight. Furthermore, SRMs also have the issue of torque ripple and noise, wherein the torque ripple is due to the “handover” of excitation from one pole to the other and noise is because of the single pole pair excitation of the stator leading to magneto strictive noise.

Moreover, the conventional simple SRMs with a single phase have been proposed which have a large torque ripple and also a starting problem, which is typically solved by placing a magnet in the stator which makes the motor rest at a suitable position. However, the solution is not applicable in all applications and unreliable because of uneven wear and tear of the machines.

In the backdrop of emerging demand/trend there is a need for a system and a method for achieving uniform torque with better utilization of material leading to better efficiencies, reduced cost and reduced size/weight and correspondingly resolve starting problem with reduction in noise and torque ripple in a Switched Reluctance Motor (SRM).

The above-mentioned shortcomings, disadvantages and problems are addressed herein, and which will be understood by reading and studying the following specification.

### Objectives of the Embodiments Herein

The primary object of the embodiments herein is to provide a multitude of single-phase Switch Reluctance Motor (SRM) system arranged in a suitable fashion, to achieve uniform torque with complete material utilization.

Another object of the embodiments herein is to provide a multiple single phase SRM system with reduction in torque ripple and noise.

Yet another object of the embodiments herein is to provide a multiple single phase SRM system which address the starting problem.

Yet another object of the embodiments herein is to provide a method for resolving starting problem in a single phase SRM system.

Yet another object of the embodiments herein is to provide multitude of single phase SRM system, to match the various application requirements such as not limited to in electric vehicles, HVAC, home appliances, motor manufacturers, drone companies, defense applications and the like.

These and other objects and advantages of the present invention will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a system for achieving uniform torque with complete material utilization, correspondingly resolve starting problem with reduction in noise and torque ripple by arranging multitude of single-phase SRM or slice in a suitable fashion. The embodiments herein, provides a method for resolving starting problem in a single phase SRM or a slice by using an auxiliary winding and auxiliary slice.

The various embodiments herein provide, a system for achieving uniform torque with complete material utilization, and correspondingly resolve torque ripple with reduction in noise in an SRM. The system comprises a plurality of slices arranged in a tandem fashion centered along an axis of rotation. The plurality of slices is single phase concentric switched reluctance motor (SRM) with equal number of rotor and stator poles. The stator poles of the consecutively arranged plurality of slices are aligned and the rotor poles of the consecutively arranged plurality of slices are off set.

According to one embodiment herein, the arrangement of the plurality of slice consists of two typical ways wiring the plurality of slices in series and parallel. Wiring the plurality of slices in series involves wiring all the stator poles of the plurality of slices in series with alternating stator poles having opposite polarity. Furthermore, wiring the plurality of slices in parallel involves wiring the adjacent stator poles of the plurality of slices in parallel to form one pole pair.

According to one embodiment herein, the offset between the consecutive rotor poles of the plurality of slices are 360/(n*p) degrees; and wherein the n is number of slices and p is the number of poles. The uniform and uninterrupted torque delivery is achieved by arranging two or more slices in tandem fashion, with slice number 2 is shifted by (360/p)/2 in case of a two-slice machine or (360/p)/3 in case of a three-slice machine, wherein p is the number of poles per each slice. Furthermore, the choice between two or three slice machines is application dependent.

According to one embodiment herein, the reduction in torque ripple can be achieved by increasing the number of the plurality of slices. Hence, as the number of slices is increased, the torque is delivered at all instants in time by one or more of the slices of the plurality of slices to reduce torque ripple. For instance, with either the 2 or 3 or more slices, machine torque is delivered at all instants in time by one of the slices thus, reducing torque ripple. Furthermore, by the excitation of all the poles in each of the plurality of slices at the same time, in each time the deformation of the stator due to magnetostriction is minimal leading to reduced noise.

According to one embodiment herein, a system for resolving starting problem in a SRM is provided. The system comprises a one or more slices arranged in a tandem fashion centered along an axis of rotation. The one or more slices are single phase concentric switched reluctance motor (SRM) with equal number of rotor and stator poles. The stator poles of the one or more slices arranged consecutively are aligned and the rotor poles of the one or more slices arranged consecutively are off set. The system further comprises an auxiliary slice positioned at an offset between the one or more slices. The auxiliary slice is a thin slice positioned at different angles with respect to the one or more slices to resolve the starting problem. The off-set of the auxiliary slice is in between the off-set of the rotors of the one or more slices. Furthermore, the system comprises an auxiliary winding to move the rotors of the one or more slices away from the aligned/unaligned position. The aligned/unaligned positions of the rotors of the one or more slices experiences starting problem and produces zero torque. The auxiliary winding is excited momentarily, while starting the system from rest and is not energized during normal operation.

According to one embodiment herein, wherein the one or more slices includes two-slice SRM. The off-set between the rotor poles of the two-slice SRM is 22.5° and the off-set of the auxiliary slice between the two-slice SRM is 11.25° with respect to each slice.

According to one embodiment herein, the auxiliary winding is excited momentarily by means of a circuit when the machine is at rest to move the rotor away from the aligned/unaligned position with respect to the two main slices. The circuit comprises a semiconductor switch such as MOSFET, auxiliary winding and a fly-back diode. A two-slice machine with symmetrical rotor and stator pole shapes will experience a starting problem at two rotor positions either fully aligned or fully unaligned, both zero torque producing positions.

According to one embodiment herein, the system comprises a plurality of poles with auxiliary windings alternatively. The plurality of poles with auxiliary windings helps to move the rotor to a suitable position while starting from the rest to resolve the starting problem.

According to one embodiment herein, the system alternatively comprises an asymmetric number of poles in each of the one or more slices to eliminate starting problem. For instance, considering slice 1 having 8 poles and slice 2 having 6 poles, thus eliminating the starting problem at a small penalty of torque ripple.

According to one embodiment herein, a method for resolving starting problem in a single phase SRM is provided. The method includes evaluating zero torque position of a rotor in a slice. The slice is a single phase Switched Reluctance Motor (SRM) with equal number of rotor and stator poles. The zero-torque position of the rotor is either rotor fully aligned or rotor fully unaligned with the stator poles. The method further includes exciting auxiliary winding momentarily by means of a circuit, if the rotor position is at zero torque position or exciting windings of the slice to continue with motor operation if the rotor position is away from the zero-torque position. The circuit for exciting auxiliary winding comprises a semiconductor switch such as MOSFET, auxiliary winding and a fly-back diode. In addition, the method includes moving the rotor either in the direction of intended rotation or in reverse direction by exciting auxiliary winding. Further, reversing the rotor direction to the direction of intended rotation by means of position detection mechanism and exciting windings of the slice to continue with the motor operation.

According to one embodiment herein, the method for excitation of auxiliary winding momentarily is provided. The method includes turning ON the semiconductor switch such as MOSFET, to energize the auxiliary winding and turning OFF the semiconductor switch such as MOSFET, to de-energize the auxiliary winding. The de-energizing the auxiliary winding involves the current in the auxiliary winding is recirculated through the fly-back diode and thereby turning OFF the circuit.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which:

FIG. 1 illustrates a cross-sectional view of a single phase Switched Reluctance Motor (SRM) or a Slice with equal number or rotor and stator poles, according to an embodiment herein.

FIGS. 2A-2B illustrates a two slice SRM and a three slice SRM arranged in a tandem fashion to achieve uniform torque with complete material utilization, according to an embodiment herein.

FIG. 2C-2D illustrates the stator poles of the slices aligned and rotor poles are off-set in a two slice and three slice SRM, according to an embodiment herein.

FIG. 3A illustrates a two slice SRM with an auxiliary slice, according to an embodiment herein.

FIG. 3B illustrates a side-view of two slice SRM with an auxiliary slice, according to an embodiment herein.

FIG. 3C illustrates an auxiliary slice positioned at an offset between two main slices of a two slice SRM, according to an embodiment herein.

FIG. 4 illustrates a circuit for exciting the auxiliary winding momentarily, according to an embodiment herein.

FIG. 5A-5G illustrates a graph of Torque vs Time, depicts multiple slices helps to reduce torque ripple, according to an embodiment herein.

FIG. 6 illustrates a flowchart of algorithm, to achieve bidirectional rotation of rotor with one auxiliary coil to address the starting problem in a slice, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a system for achieving uniform torque with complete material utilization, correspondingly resolve starting problem with reduction in noise and torque ripple by arranging multitude of single-phase SRM or slice in a suitable fashion. The embodiments herein, provides a method for resolving starting problem in a single phase SRM or a slice by using an auxiliary winding and auxiliary slice.

The various embodiments herein provide, a system for achieving uniform torque with complete material utilization, and correspondingly resolve torque ripple with reduction in noise in an SRM. The system comprises a plurality of slices arranged in a tandem fashion centered along an axis of rotation. The plurality of slices is single phase concentric switched reluctance motor (SRM) with equal number of rotor and stator poles. The stator poles of the consecutively arranged plurality of slices are aligned and the rotor poles of the consecutively arranged plurality of slices are off set.

According to one embodiment herein, the arrangement of the plurality of slice consists of two typical ways wiring the plurality of slices in series and parallel. Wiring the plurality of slices in series involves wiring all the stator poles of the plurality of slices in series with alternating stator poles having opposite polarity. Furthermore, wiring the plurality of slices in parallel involves wiring the adjacent stator poles of the plurality of slices in parallel to form one pole pair.

Furthermore, although the arrangement of the plurality of slices is identical in performance and other characteristics, the principal difference being the inductance and resistance produced by the drive circuit. Hence, with either of the arrangements excited by the drive circuit there is achieved full utilization of the material of the slice, thereby leading to higher efficiencies and reduced costs.

According to one embodiment herein, the offset between the consecutive rotor poles of the plurality of slices are 360/(n*p) degrees; and wherein the n is number of slices and p is the number of poles. The uniform and uninterrupted torque delivery is achieved by arranging two or more slices in tandem fashion, with slice number 2 is shifted by (360/p)/2 in case of a two-slice machine or (360/p)/3 in case of a three-slice machine, wherein p is the number of poles in each slice. Furthermore, the choice between two or three slice machines is application dependent.

According to one embodiment herein, by maintaining uniform offset between the different slices, it is ensured that at least one slice is in torque producing region for any given rotor position. Thus, the starting problem is largely avoided. For machines with 3 or more slices, there will not be a starting problem at any rotor position.

According to one embodiment herein, the reduction in torque ripple can be achieved by increasing the number of the plurality of slices. Hence, as the number of slices is increased, the torque is delivered at all instants in time by one or more of the slices of the plurality of slices to reduce torque ripple. For instance, with either the 2 or 3 or more slices, machine torque is delivered at all instants in time by one of the slices thus, reducing torque ripple. Furthermore, by the excitation of all the poles in each of the plurality of slices at the same time, in each time the deformation of the stator due to magnetostriction is minimal leading to reduced noise.

According to one embodiment herein, a system for resolving starting problem in a SRM is provided. The system comprises one or more slices arranged in a tandem fashion centered along an axis of rotation. The one or more slices are single phase concentric switched reluctance motor (SRM) with equal number of rotor and stator poles. The stator poles of the one or more slices arranged consecutively are aligned and the rotor poles of the one or more slices arranged consecutively are off set. The system further comprises an auxiliary slice positioned at an offset between the one or more slices. The auxiliary slice is a thin slice positioned at different angles with respect to the one or more slices to resolve the starting problem. The off-set of the auxiliary slice is in between the off-set of the rotors of the one or more slices. Furthermore, the system comprises an auxiliary winding to move the rotors of the one or more slices away from the aligned/unaligned position. The aligned/unaligned positions of the rotors of the one or more slices experiences starting problem and produces zero torque. The auxiliary winding is excited momentarily, while starting the system from rest, and the auxiliary winding is not energized during normal operation.

According to one embodiment herein, wherein the one or more slices includes two-slice SRM. The off-set between the rotor poles of the two-slice SRM is 22.5° and the off-set of the auxiliary slice between the two-slice SRM is 11.25°.

According to one embodiment herein, the auxiliary winding is excited momentarily by means of a circuit when the machine is at rest to move the rotor away from the aligned/unaligned position with respect to the two main slices. The circuit comprises a semiconductor switch such as MOSFET, auxiliary winding and a fly-back diode. A two-slice machine with symmetrical rotor and stator pole shapes will experience a starting problem at two rotor positions either fully aligned or fully unaligned, both zero torque producing positions.

According to one embodiment herein, the system comprises a plurality of poles with auxiliary windings alternatively. The plurality of poles with auxiliary windings helps to move the rotor to a suitable position while starting from the rest to resolve the starting problem.

According to one embodiment herein, the system alternatively comprises an asymmetric number of poles in each of the one or more slices to eliminate starting problem. For instance, considering slice 1 having 8 poles and slice 2 having 6 poles, thus eliminating the starting problem at a small penalty of torque ripple.

According to one embodiment herein, a method for resolving starting problem in a single phase SRM is provided. The method includes evaluating zero torque position of a rotor in a slice. The slice is a single phase Switched Reluctance Motor (SRM) with equal number of rotor and stator poles. The zero-torque position of the rotor is either rotor fully aligned or rotor fully unaligned with the stator poles. The method further includes exciting auxiliary winding momentarily by means of a circuit, if the rotor position is at zero torque position or exciting windings of the slice to continue with motor operation if the rotor position is away from the zero-torque position. The circuit for exciting auxiliary winding comprises a semiconductor switch such as MOSFET, auxiliary winding and a fly-back diode. In addition, the method includes moving the rotor either in the direction of intended rotation or in reverse direction by exciting auxiliary winding. Further, reversing the rotor direction to the direction of intended rotation by means of position detection mechanism and exciting windings of the slice to continue with the motor operation.

According to one embodiment herein, the method for excitation of auxiliary winding momentarily is provided. The method includes turning ON the semiconductor switch such as MOSFET, to energize the auxiliary winding and turning OFF the semiconductor switch such as MOSFET, to de-energize the auxiliary winding. The de-energizing the auxiliary winding involves the current in the auxiliary winding is recirculated through the fly-back diode and thereby turning OFF the circuit.

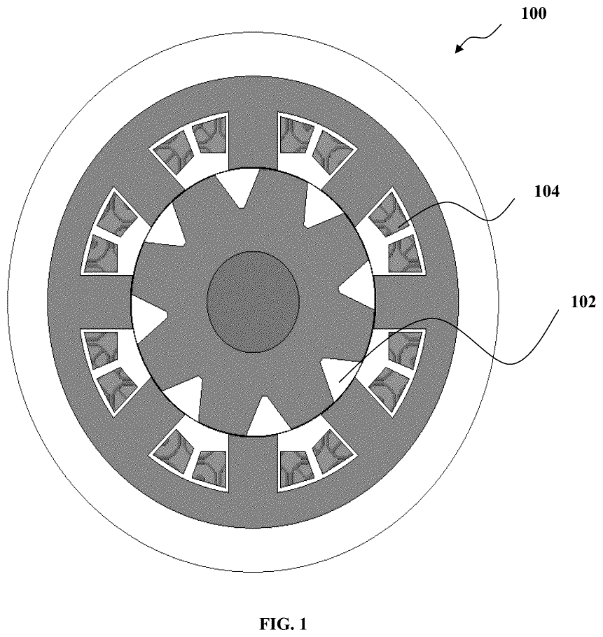

According to one embodiment herein, FIG. 1 illustrates a cross-sectional view of a single phase Switched Reluctance Motor (SRM) or Slice with equal number of rotor and stator poles. FIG. 1 illustrates a single phase (Slice) Switched Reluctance Motor SRM 100 with eight rotors 102 and stator poles 104. A single-phase SRM 100 is also known as a Slice. The number of poles will be based on engineering optimizations, which are application specific. Since there are equal number of stator and rotor poles each slice has the ability to run as single-phase machine.

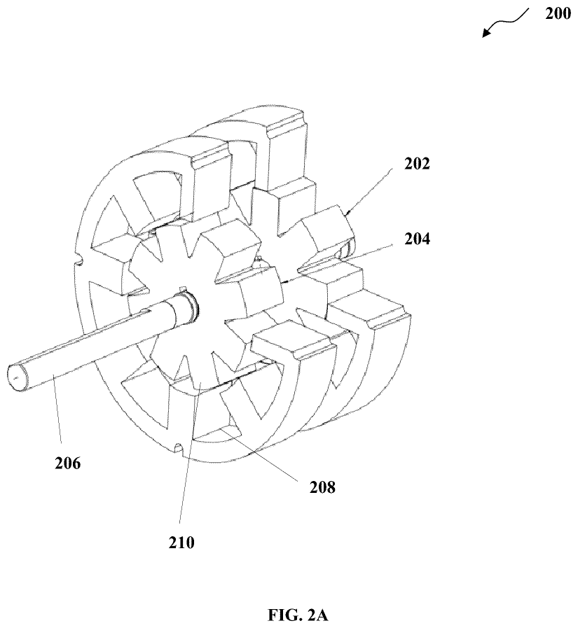

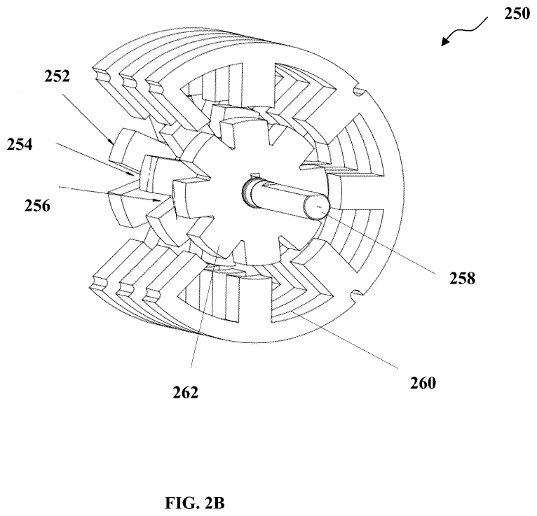

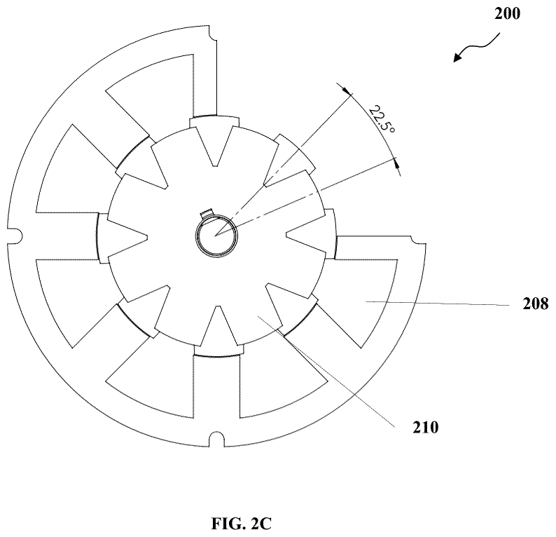

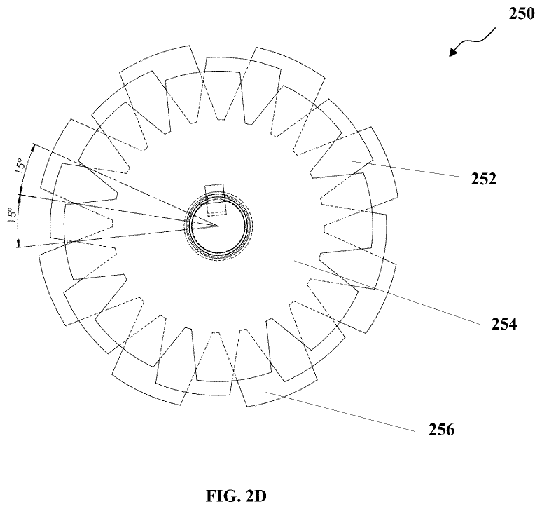

According to one embodiment herein, FIGS. 2A-2B illustrates a two slice SRM and a three slice SRM arranged in a tandem fashion to achieve uniform torque with complete material utilization.

FIG. 2A illustrates a two slice SRM 200 with 8 rotor and stator poles. Each slice 202 and 204 are concentric single-phase SRM arranged in a tandem fashion along an axis of rotation 206. The stator 208 of both the slices 202 and 204 are aligned, but the rotor poles 210 are off set.

FIG. 2B illustrates a illustrates a three slice SRM 250 with 8 rotor and stator poles. Each slice 252, 254 and 256 are concentric single-phase SRM arranged in a tandem fashion along an axis of rotation 258. The stator 260 of all the slices 252, 254 and 256 are aligned, but the rotor poles 262 are off set.

According to one embodiment herein, FIG. 2C-2D illustrates the stator poles of the slices are aligned and rotor poles are off-set in a two slice and three slice SRM.

FIG. 2C illustrates a two-slice SRM 200 with 8 rotor and stator poles. The stator poles 208 of two slices and are aligned and rotor poles 210 are off set. The rotor poles are off set at an angle of 22.5°. For n-number of slices and p-number of poles the off-set is calculated by 360/(n*p).

FIG. 2D illustrates a three slice SRM 250 with 8 rotor and stator poles. The stator poles of all the slices 252, 254 and 256 are aligned and rotor poles are off set. The rotor poles are off set at an angle of 15°. For n-number of slices and p-number of poles the off-set is calculated by 360/(n*p).

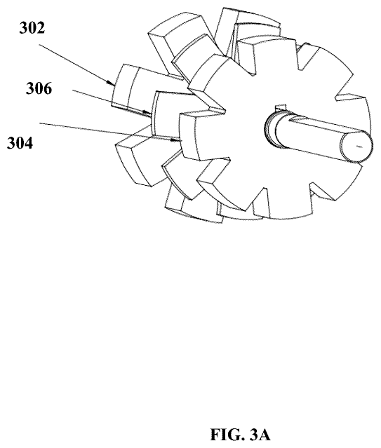

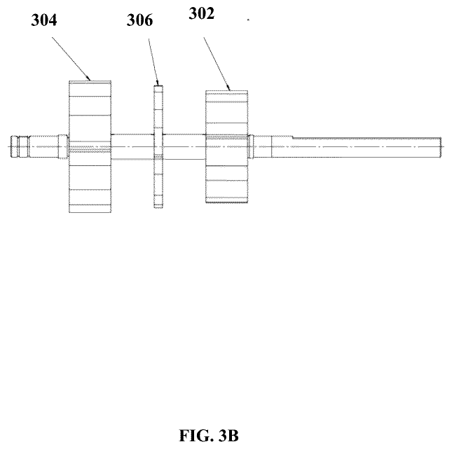

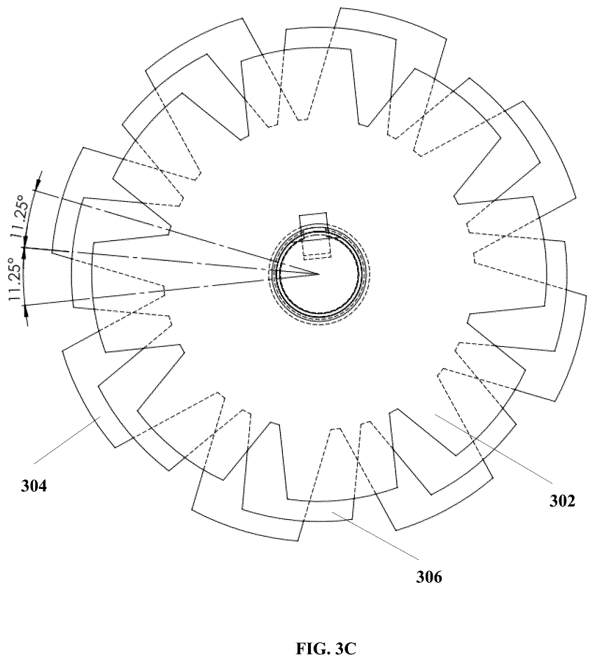

According to one embodiment herein, FIG. 3A illustrates a two slice SRM with an auxiliary slice. FIG. 3A illustrates a two-slice SRM including two slices 302 and 304 with an auxiliary slice 306. The auxiliary slice 306 is a thin slice positioned at different angles with respect to the two main slices 302 and 304 to resolve the starting problem. The auxiliary slice 306 is positioned at an offset between two main slices 302 and 304. The off-set of the auxiliary slice is in between the off-set of the rotors of the two main slices 302 and 304.

According to one embodiment herein, FIG. 3B illustrates a side-view of two slice SRM with an auxiliary slice. FIG. 3B illustrates a two-slice SRM including two slices 302 and 304 with an auxiliary slice 306.

According to one embodiment herein, illustrates an auxiliary slice positioned at an offset between two main slices of a two slice SRM. FIG. 3C illustrates the auxiliary slice 306 is positioned at an offset between two main slices 302 and 304. The off-set of the auxiliary slice 306 is in between the off-set of the rotors of the two main slices 302 and 304 at 11.25°. The rotors of the two-main slices 302 and 304 are off-set at 22.5°, wherein the off-set between the rotors in a multiple sliced SRM is calculated by 360/(n*p) where n is the number of slices and p is the number of poles. The off-set of the auxiliary slice 306 is in between the off-set of the rotors of the two main slices 302 and 304, which is at 11.25°.

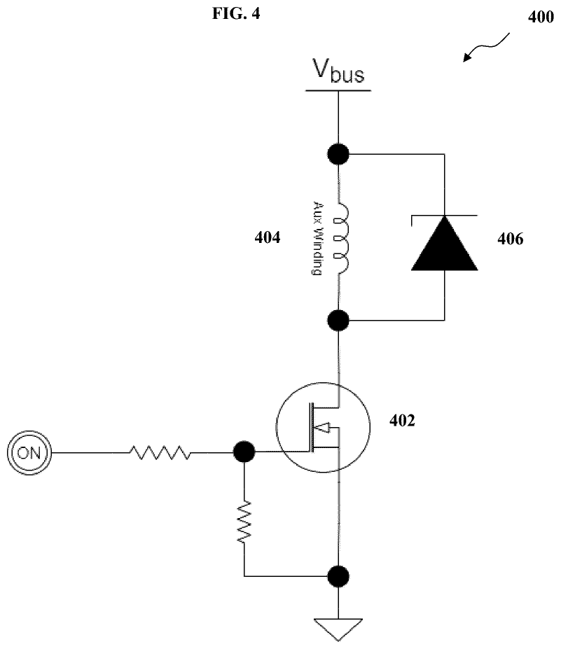

According to one embodiment herein, FIG. 4 illustrates a circuit for exciting the auxiliary winding momentarily. FIG. 4 illustrates a circuit 400 for exciting the auxiliary winding momentarily. The auxiliary winding is excited momentarily by means of a circuit 400 when the machine is at rest to move the rotor away from the aligned/unaligned position with respect to the main slices. The circuit 400 comprises a semiconductor switch such as MOSFET 402, auxiliary winding 404 and a fly-back diode 406. A two-slice machine with symmetrical rotor and stator pole will experience a starting problem at two rotor positions either fully aligned or fully unaligned, both zero torque producing positions. Hence, the auxiliary winding 404 is excited momentarily with the help of a circuit 400 to overcome the zero-torque position. The auxiliary winding 404 is excited only when the machine is at rest and not during normal operation. The method includes turning ON the semiconductor switch such as MOSFET 402, to energize the auxiliary winding 404 and turning OFF the semiconductor switch such as MOS FET 402, to de-energize the auxiliary winding 404. The de-energizing the auxiliary winding 404 involves the current in the auxiliary winding is recirculated through the fly-back diode 406 and thereby turning OFF the circuit 400.

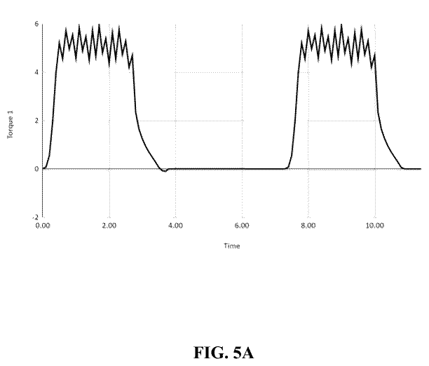

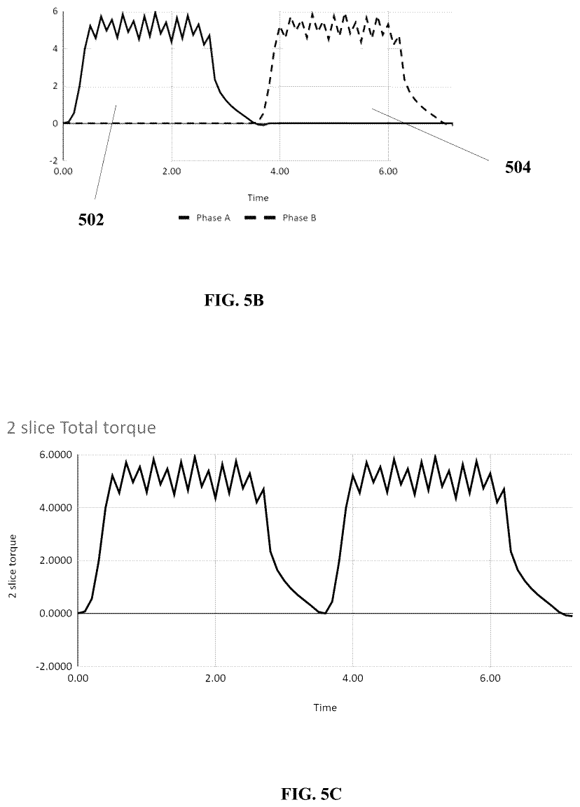

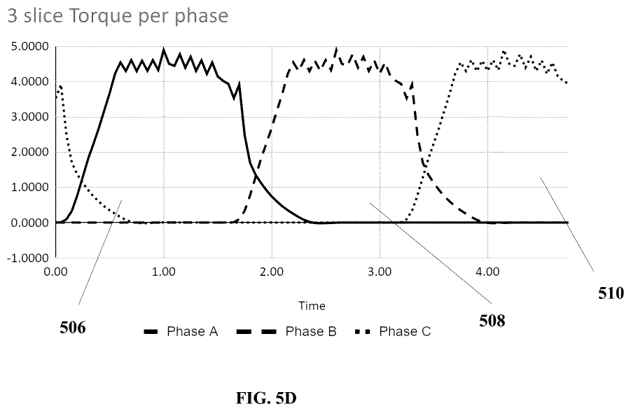

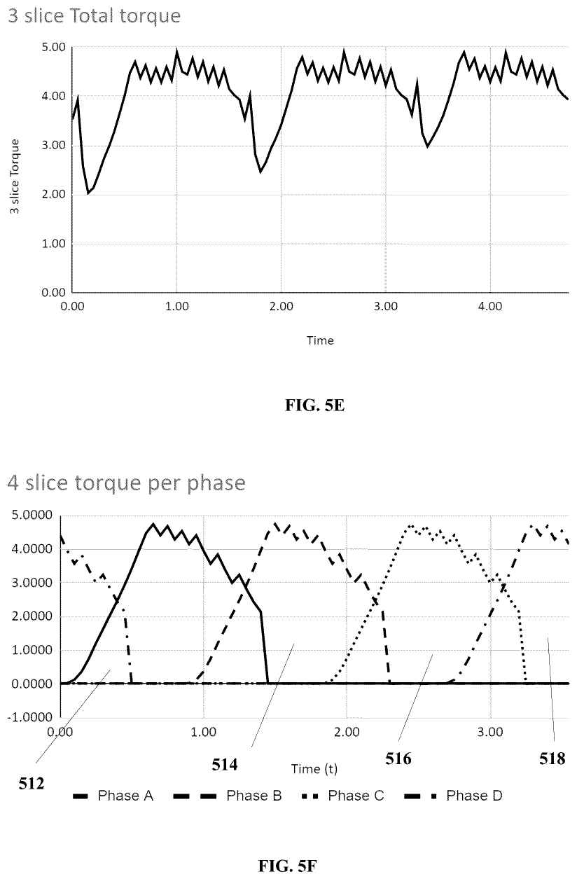

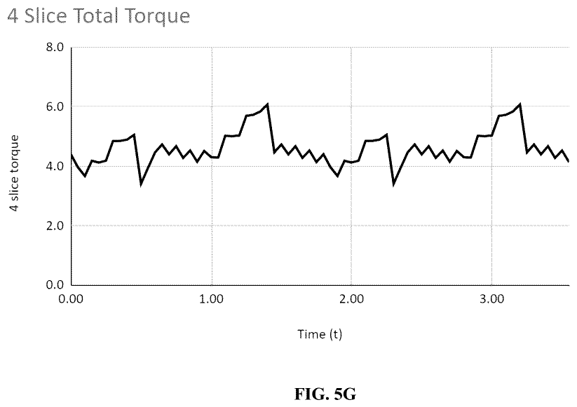

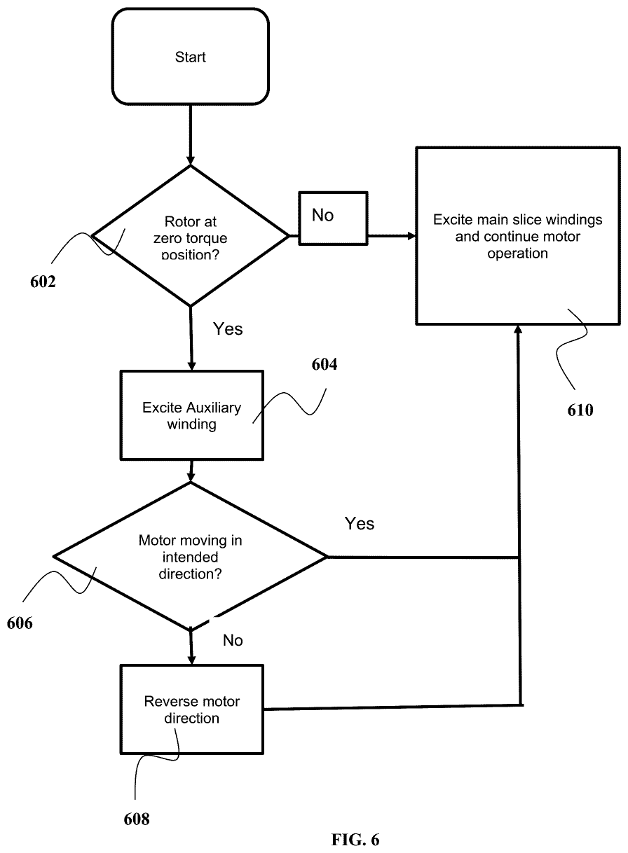

According to one embodiment herein, FIG. 5A-5G illustrates a graph of Torque vs Time, depicts multiple slices helps to reduce torque ripple, according to an embodiment herein.

FIG. 5A illustrates the torque output in a single phase SRM or one slice which contributes for a long time zero torque position, thus experiencing large amount of torque ripple.

FIG. 5B illustrates the phase-wise torque output of a two-slice SRM. 502 depicts the torque output of phase A or slice 1 SRM and 504 depicts the torque output of phase B or slice 2 SRM.

FIG. 5C illustrates the total torque output of a two slice SRM, wherein the torque ripple is minimal in comparison with a single phase SRM.

FIG. 5D illustrates the phase-wise torque output of a three-slice SRM. 506 depicts the torque output of phase A or slice 1 SRM, 508 depicts the torque output of phase B of slice 2 SRM and 510 depicts the torque output of the phase C or slice 3 SRM.

FIG. 5E illustrates the total torque output of a three slice SRM, wherein the torque ripple is minimized in comparison with a two slice SRM.

FIG. 5F illustrates the phase-wise torque output of a four-slice SRM. 512 depicts the torque output of phase A or slice 1 SRM, 514 depicts the torque output of phase B of slice 2 SRM, 516 depicts the torque output of phase C or slice 3 SRM and 518 depicts the torque output of the phase D or slice 4 SRM.

FIG. 5G illustrates the total torque output of a four slice SRM, wherein the torque ripple is completely minimized in comparison with a three slice SRM. Hence in comparison with FIG. 5A-5G it can be seen that as the number of slices are increased, the total torque is smoother with lesser ripple.

According to one embodiment herein, FIG. 6 illustrates a flowchart of algorithm, to achieve bidirectional rotation of rotor with one auxiliary coil to address the starting problem in a slice. At step 602, the zero-torque position of a rotor in a slice is evaluated. The slice is a single phase Switched Reluctance Motor (SRM) with equal number of rotor and stator poles. The zero-torque position of the rotor is either rotor fully aligned or rotor fully unaligned with the stator poles. At step 604, the auxiliary winding is momentarily excited by means of a circuit, if the rotor position is at zero torque position or the winding of the main slice is excited at step 610 to continue with motor operation if the rotor position is away from the zero-torque position. The circuit for exciting auxiliary winding comprises a semiconductor switch such as MOSFET, auxiliary winding and a fly-back diode. At step 606, the rotor is moved either in the direction of intended rotation or in reverse direction by exciting auxiliary winding at step 604. Further at step 608, the rotor direction is reversed to the direction of intended rotation by means of position detection mechanism and the winding of the main slice is excited at step 610 to continue with the motor operation.

From the foregoing discussion, it is apparent that the concept of series of single phase SRM slices arranged along an axis or concentrically would achieve complete material utilization leading to higher efficiencies. Multiple slices aid to reduce torque ripple. Excitation of all the poles in a single phase SRM will reduce the noise. Furthermore, the use of small auxiliary winding will solve the starting problem in the case of a two-slice machine, wherein there is zero effect on performance by the auxiliary winding during normal operation unlike the introduction of a permanent magnet.

Although the embodiments herein are described with various specific embodiments, it will be obvious for a person skilled in the art to practice the embodiments herein with modifications.

The system and method for system for achieving uniform torque with complete material utilization, and correspondingly resolve starting problem with reduction in noise and torque ripple disclosed in the embodiments herein have several exceptional advantages. The system comprising multitude of single-phase Switch Reluctance Motor (SRM) arranged in a suitable fashion in order to achieve uniform torque with complete material utilization. The system also provides a series of single-phase Switch Reluctance Motor (SRM) arranged in appropriate manner for better utilization of material leading to better efficiencies, reduced cost and reduced size or weight. In addition, by employing multiple slices in the system helps to reduce the torque ripple and excitation of all the poles in a single phase SRM will reduce the noise. Furthermore, the use of small auxiliary winding will resolve the starting problem in the case of a two-slice machine, wherein there is zero effect on performance by the auxiliary winding during normal operation unlike the introduction of a permanent magnet. Furthermore, multitude of single phase SRM system provides various application requirements such as not limited to in electric vehicles, HVAC, home appliances, motor manufacturers, drone companies, defense applications and the like.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A system for achieving uniform torque with complete material utilization, and correspondingly resolve torque ripple with reduction in noise in a SRM comprising:
a plurality of slices arranged in a tandem fashion centered along an axis of rotation; and
wherein the plurality of slices is single phase concentric switched reluctance motor (SRM) with equal number of rotor and stator poles, and wherein the stator poles of the plurality of slices arranged consecutively is aligned and wherein the rotor poles of the plurality of slices arranged consecutively is in off-set;
wherein the plurality of slices comprises wiring in series or in parallel, and wherein the wiring the plurality of slices in series involves wiring the stator poles of the plurality of slices in series with alternating stator poles having opposite polarity, and wherein wiring the plurality of slices in parallel involves wiring the adjacent stator poles of the plurality of slices in parallel to form one pole pair;
wherein the offset between the consecutive rotor poles of the plurality of slices are 360/(n*p); and wherein the n is number of slices and p is the number of poles, and
wherein the offset between the consecutive rotos poles is determined based on the application demands or motor topology; and
wherein the torque is delivered at all instants in time by one or more of the slices of the plurality of slices to reduce torque ripple by increasing the number of the plurality of slices.

2. The system according to claim 1, wherein the rotor positions are offset symmetrically to ensure that there is at least one slice in torque producing region for any given rotor position, thereby avoiding the starting problem for most positions in a two slice SRM, and wherein, there is no starting problem at any given rotor position for SRMs, with three or more slices.

3. A system for resolving starting problem in a SRM comprising:
a one or more slices arranged in a tandem fashion centered along an axis of rotation, and wherein the one or more slices are single phase concentric switched reluctance motor (SRM) with equal number of rotor and stator poles, and wherein the stator poles of the one or more slices arranged consecutively are aligned and wherein the rotor poles of the one or more slices arranged consecutively are off set.
an auxiliary slice positioned at an off-set between the one or more slices; and wherein the off-set of the auxiliary slice is in between the off-set of the rotors of the one or more slices; and
an auxiliary winding, to move the rotors of the one or more slices away from the aligned/unaligned position, and wherein the aligned/unaligned positions of the rotors of the one or more slices experiences starting problem and produces zero torque, and wherein the auxiliary winding is excited momentarily, while starting the system from rest and not during normal operation.

4. The system according to claim 3, wherein the one or more slices includes two-slice SRM, and wherein the off-set between the rotor poles of the two-slice SRM is 22.5°, and wherein the off-set of the auxiliary slice between the two-slice SRM is 11.25°.

5. The system according to claim 3, wherein the auxiliary slice is positioned at a different offset between the slices, based on the application demands or motor topology.

6. The system according to claim 3, wherein the auxiliary winding is excited momentarily by means of a circuit, and wherein the circuit comprises a semiconductor or electromechanical switch, auxiliary winding, and a fly-back diode, and wherein the semiconductor or electromechanical switch is MOSFET, IGBT, Relay or other switching device.

7. The system according to claim 3, comprises a second set of poles with auxiliary windings alternatively, and wherein the second set of poles with auxiliary windings helps to move the rotor to a suitable position while starting from the rest to resolve the starting problem.

8. The system according to claim 3, comprises an asymmetric number of poles alternatively in each of the one or more slices to eliminate the starting problem.

9. A method for resolving starting problem in a single phase SRM comprising the steps of:
evaluating zero torque position of a rotor in a slice, and wherein the slice is a single phase Switched Reluctance Motor (SRM) with equal number of rotor and stator poles, and wherein the zero-torque position of the rotor is either rotor fully aligned or rotor fully unaligned with the stator poles;
exciting auxiliary winding momentarily by means of a circuit, if the rotor position of step (a) is at zero torque position or exciting windings of the slice to continue with motor operation, if the rotor position of step (a) is away from the zero-torque position, and wherein the circuit for exciting auxiliary winding comprises a semiconductor or electromagnetic switch, auxiliary winding and a fly-back diode, and wherein the semiconductor or electromagnetic switch is MOSFET, IGBT, Relay or other switching device;
moving the rotor either in the direction of intended rotation or in reverse direction by exciting auxiliary winding of step (b);
reversing the rotor direction to the direction of intended rotation by means of position detection mechanism; and
exciting windings of the slice to continue with the motor operation.

10. The method according to claim 9, wherein the excitation of auxiliary winding momentarily comprises the steps of:
turning ON the semiconductor switch, to energize the auxiliary winding;
turning OFF the semiconductor switch, to de-energize the auxiliary winding; and
wherein the de-energizing the auxiliary winding involves the current in the auxiliary winding is recirculated through the fly-back diode and turning OFF the circuit.
